(19) United States
(12) Patent Application Publication
(10) Pub. No.: US 2022/0396916 A1
(43) Pub. Date: Dec. 15, 2022

(54) Pulp Treating Apparatus and Method

(71) Applicant: Valmet Technologies Oy, Espoo (FI)

(72) Inventors: Tuomo Kälkäjä, Espoo (FI); Antti Haapala, Joensuu (FI)

(73) Assignee: Valmet Technologies Oy, Espoo (FI)

(21) Appl. No.: 17/613,055

(22) PCT Filed: May 22, 2020
(86) PCT No.: PCT/EP2020/064307

§ 371 Date: Nov. 20, 2021

(30) Foreign Application Priority Data
Jun. 6, 2019 (FI) 20195481

(51) Int. Cl. D21C 9/00; D21H 11/18

(52) U.S. Cl. CPC D21C 9/007; D21H 11/18

(57) ABSTRACT

A pulp treating arrangement (10) has a pulp treating apparatus (100), which receives a first pulp (150) which including at least one of virgin pulp (152) and recycled pulp (154). The arrangement performs a processing of fines of the first pulp (150), and outputs a second pulp (160) having a modified percentage of fines on the basis of the processing and provides a micro-/nanocellulose process arrangement (104) with the second pulp (160).

### CROSS REFERENCES TO RELATED APPLICATIONS

This application is a U.S. National Stage Entry application of international App. No.: PCT/EP2020/064307, filed May 22, 2020, which claims priority on Finnish App. No. 20195481 filed Jun. 6, 2019, the disclosures of both of which applications are incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to a pulp treating apparatus and a pulp treating method.

Nanocellulose materials from wood may be classified as cellulose nanocrystals (CNC) or cellulose nanofibrils (CNF) that exhibit distinct properties that make them better suited to be used in some specific applications. Cellulose nanofibrils (CNF) have amorphous and crystalline domains and a spaghetti-like structure, differing from CNCs that have almost perfect crystallinity (˜90%), a much smaller aspect ratio and a rigid needle like appearance. These nano-sized cellulose units, with dimensions of approximately 5 nm-50 nm in diameter and up to millimeters of length, may be further bonded creating a network in the supramolecular cellulose structure.

A pulp product based on plant cellulose is a typical feedstock from which the micro and/or nanocelluloses are manufactured. It is not uniform in terms of particle size and chemical composition, which leads to problems when the pulp product is used as a feedstock to a microcellulose and/or nanocellulose manufacturing process. The pulp may react poorly to a pre-treatment, a longer time, more energy or more chemicals may be required for the pre-treatment, process equipment may clog, and/or a product with non-fibrillar/crystalline particles may result. Each of these features alone or in any combination decreases quality of the product Hence, there is a need for improvement.

### SUMMARY OF THE INVENTION

The present invention seeks to provide an improvement in the treatment. The pulp treating arrangement (10) has a pulp treating apparatus (100), which receives a first pulp (150) which including at least one of virgin pulp (152) and recycled pulp (154). The arrangement performs a processing of fines of the first pulp (150), and outputs a second pulp (160) having a modified percentage of fines on the basis of the processing and provides a micro-/nanocellulose process arrangement (104) with the second pulp (160).

### BRIEF DESCRIPTION OF THE DRAWINGS

Example embodiments of the present invention are described below, by way of example only, with reference to the accompanying drawings.

FIG. 1 is a schematic view of an example of a pulp treating arrangement,

FIG. 2 is a schematic view of an example of the pulp treating arrangement with a controller.

FIG. 3 is a schematic view of an example of a multi-stage pulp treatment.

FIG. 4 is a schematic view of an example of a cascade of pulp treatments.

FIG. 5 is a schematic view of an example of a controller.

FIG. 6 is a schematic view of an example of a flow chart of the pulp treatment method.

### DESCRIPTION OF THE PREFERRED EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, the words “comprising” and “including” should be understood as not limiting the described embodiments to consist only of those features that have been mentioned and such embodiments may contain features/structures that have not been specifically mentioned. All combinations of the embodiments are considered possible if their combination does not lead to structural or logical contradiction.

It should be noted that while the figures illustrate various embodiments, they are simplified diagrams that only show some structures and/or functional entities. The connections shown in the figures may refer to logical or physical connections. It is apparent to a person skilled in the art that the described apparatus may also comprise other functions and structures than those described in the figures and text. It should be appreciated that details of some functions, structures, and the signaling used for measurement and/or controlling are irrelevant to the actual invention. Therefore, they need not be discussed in more detail here. As a consequence of current pulping practices, the extractive-rich pulp fines fractions are not retained in chemical or mechanical pulping processes and hence the pulp product is not pure and uniform in terms of particle size and chemical composition, for example. Some of the particles within the fines category may be almost inert to chemical reactions by the pulping and bleaching chemicals. Most typical examples of this include the fines and other particles from bark, knots, resin canals or secreted heartwood that have a high content of extractives and resin and fatty acid compounds in comparison to the conventional cellulosic plant cells i.e., tracheid cells and vessel elements. In an industrial setting, these are all conventionally considered as fibers.

As a feedstock to micro- and nanocellulose manufacturing processes, particularly these inert fines of physically small plant cell types react poorly to chemical pre-treatment in comparison to the fiber fraction.

For micro- and nanocellulose processing, regardless of the approach, the weak or merely uneven reaction to the pre-treatment may cause prolonged treatment time to have sufficient reactiveness to and/or homogeneity from chemical or enzymatic pre-treatments. The weak reaction to the pre-treatment may also cause higher energy consumption in the mechanical disintegration stages regardless of the method applied. Additionally, or alternatively, the weak reaction to the pre-treatment may also cause a presence of inert fines throughout the process that may cause process equipment clogging in homogenization and microfluidization processes, or simply lead to the presence of unwanted product quality deterring the fibrillar aggregates in the product instead of individual fibrils or crystals. For the final micro- or nanocellulose product processed thereof, this may cause a wider product particle size distribution and a presence of non-fibrillar/crystalline particles in the product as fragments from the inert fines after their micronization.

Hence, an improvement may be provided for the manufacturing stages of micro- and/or nanocellulose products via product and process related measurements and automated control systems in a manner explained herein.

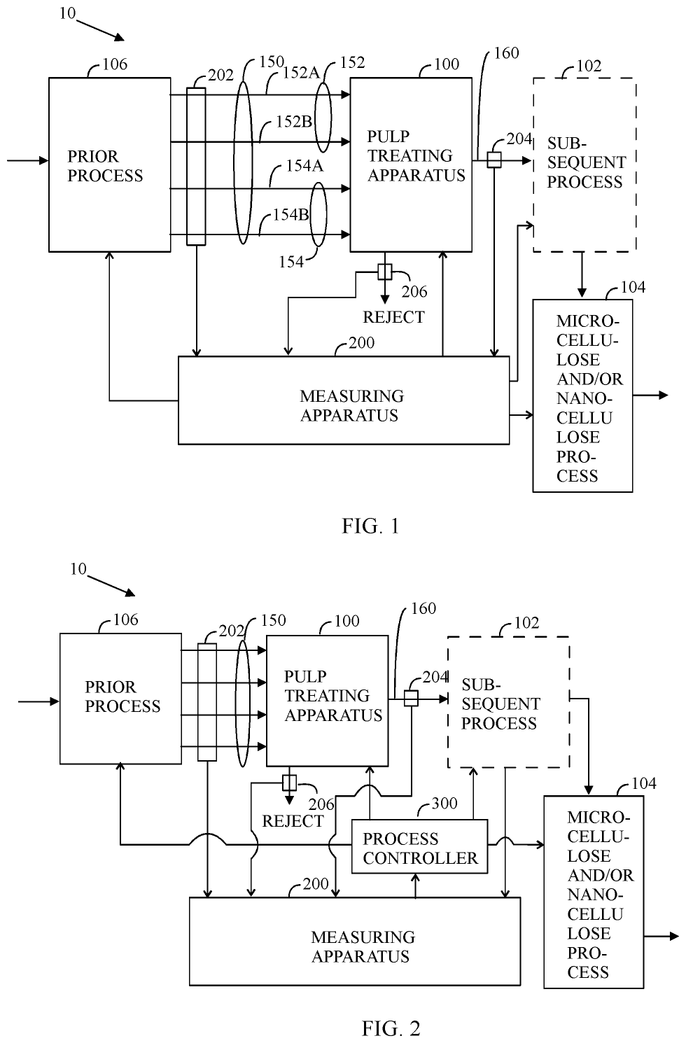

FIG. 1 illustrates an example of a pulp treating arrangement 10 that comprises a pulp treating apparatus 100. The pulp treating apparatus 100 receives first pulp 150, which includes at least one of the following: virgin pulp 152 and recycled deinked pulp 154. In an embodiment, the recycled pulp 154 may be deinked pulp. In an embodiment, the recycled pulp 154 may be non-deinked pulp. In an embodiment, the recycled pulp 154 may include both deinked pulp and non-deinked pulp. There may be one type of virgin pulp 152 or a plurality of types of virgin pulp 152. In a corresponding manner, there may be one type of recycled pulp 154 or a plurality of types of recycled pulp 154.

The type of virgin pulp 152 may depend on a tree or plant species from which the fibers of pulp originate, and/or a process by which the virgin pulp is made, such as chemical pulping, mechanical pulping, or any combination thereof, for example.

The recycled pulp 154 includes pulp made of recycled paper. The type of recycled pulp 154 may depend on types of paper from which the fibers of pulp originate. The types of the paper of the recycled pulp may additionally or alternatively depend on additional materials used within and/or on the paper or other cellulose materials. The term “cellulose based raw material” or “pulp” refers to cellulosic material, which has been obtained from any plant-, animal- or bacteria-based or -derived cellulosic material containing cellulose and/or lignocellulose, including secondary materials such as industrial residues, side-streams, wastes and recycled proportions of said materials. Said material may also be industrial pulp fibers from wood, non-wood or recycled natural fiber sources.

The recycled pulp 154 has gone through a recycling process, where fibers and possibly other particles have been processed. Typically, the processing separates the fibers and other particles from each other. A person skilled in the art is familiar with the recycling, per se. The deinked pulp has gone through a deinking process, where ink particles have more or less been removed from the pulp, before potentially entering the pulp treating apparatus 100. A recycling and/or deinking process, the recycling process being considered to include the deinking process, may also modify a number of all particles that have the same size distribution as the ink particles. That is, although the recycled pulp, which may also be deinked or not, has fines, the percentage of fines is not necessarily high. The modification of all particles may mean a decrease/reduction or increase of the particles.

Paper fibers may only be reused several times. However, it is usually not known how many times paper fibers have been reused when they are recycled. Paper fibers that have gone through recycling too many times may be broken and have decreased in quality otherwise, which may correspondingly cause the product to have a low quality. Here the term “product” may mean an end product of the pulp treating apparatus 100. Alternatively, the term “product” may mean an end product of a larger process complex of a plurality of processes in addition to the process of the pulp treating apparatus 100. The product may be produced in or by a facility or a factory that uses paper fibers as a raw material.

The virgin fibers i.e., fibers, which have not been recycled even once, have a brighter appearance and are also otherwise suitable for a microcellulose and/or nanocellulose process. In addition, paper made of virgin fibers is brighter and the fibers have better quality than those which have gone through several recycling cycles.

The pulp treating apparatus 100 performs a processing such as separation of fines from the first pulp 150, and outputs a second pulp 160 having a modified percentage of fines based on the separation. The modified percentage of fines may mean a reduced percentage or an increased percentage. A reject that includes more or less fines maybe removed from the pulp treating apparatus 100. The percentage may refer to a relative mass of fines in the measured pulp, a relative volume of fines in the measured pulp or a number of fines particles with respect to other particles in the measured pulp.

The pulp treating apparatus 100 provides a micro-/nanocellulose process arrangement 104 with the second pulp 160 directly or indirectly.

In an embodiment, it is possible that the second pulp 160 is fed from the pulp treating apparatus 100 to at least one subsequent process 102 which is between the pulp treating apparatus 100 and the micro-/nanocellulose process arrangement 104. In an embodiment, it is possible that the second pulp 160 is directly fed from the pulp treating apparatus 100 to the micro-/nanocellulose process arrangement 104, which is then the subsequent process 102.

Typically, the production of the micro-/nanocellulose in the micro-/nanocellulose process arrangement 104 may be called liberating nanofibers (extraction or liberation), which refers to breaking or delaminating the laminated structure of the wood fibers to single cell-wall building elements, which nanocellulose in practice is. The production process usually involves a chemical or enzymatic pre-treatment, which aims to weaken the chemical bonds inside the fibers, which hold these fiber fibrils closely connected together via tightly packed hydrogen bonds. This is followed by washing with water and/or with a solvent and some sort of mechanical treatment or other method, in which the weakened fiber is finally disintegrated to micro- or nanoscale fibers (fibrils or crystals). Many commercial processes are largely based on effective pulverization and a pre-treatment is not always needed.

Nanocellulose refers to nano-structured cellulose, and correspondingly microcellulose refers to micro-structured cellulose that are understood to encompass various cellulose structures liberated from cellulosic material, such as pulp from hardwood or softwood that can be observed at micrometer or nanometer scales most commonly defined by the particle width dimension. The terms microcellulose and nanocellulose have somewhat mixed use and that is why the name is the microcellulose and/or nanocellulose in this document. The microcellulose and/or nanocellulose may be understood to be microfibrillated cellulose, microbial nanocellulose produced by microbes such as bacteria, or to be of cellulose nanocrystal or to have cellulose nanofibers. The micro-/nanocellulose process arrangement performs a process a product of which is the microcellulose and/or nanocellulose. The manufacturing process of the microcellulose and/or nanocellulose is known, per se, to a person skilled in the art.

In publications in the field of nanocellulose technology, the following terms, for example, have been used for describing the nanocellulose according to what is meant to be encompassed with said term within this document; nanofibrillar cellulose, cellulose nanofiber, nanofibril cellulose, nanofibrillated cellulose, nano-scale fibrillated cellulose, microfibrillar cellulose, cellulose microfibrils, microfibrillated cellulose. Nanocellulose is also meant to encompass rod-shaped cellulose nanocrystals (CNC), or so called “nano whiskers”.

In an embodiment, the pulp treating apparatus 100 may perform the processing of fines of the first pulp 150 on the basis of reception of a plurality of types of the first pulp 150. The processing of fines may include a separation of fines from the first pulp 150. Because different types of pulp may require different energy or different chemicals for separation, the pulp treating apparatus 100 may modify the process on the basis of the type of the first pulp. That increases the effectiveness of the process such as separation.

In an embodiment, the pulp treating apparatus 100 may receive a plurality of types of the first pulp 150, the plurality of the types 152A, 152B of the first pulp 150 including a plurality of types of the virgin pulp 152, a plurality of types 154A, 154B of the recycled pulp 154, or both at least one type of the virgin pulp 152 and at least one type of the recycled pulp 154. The pulp treating apparatus 100 may then adjust separately receptions of the plurality of the types of the first pulp 150. The reception of the types 152A, 152B, 154A, 154B of the first pulp 150 may be adjusted by controlling the availability of the types 152A, 152B, 154A, 154B of the first pulp 150. Additionally, or alternatively, the reception of the types 152A, 152B, 154A, 154B of the first pulp 150 may be adjusted by controlling the intake or access of the types 152A, 152B, 154A, 154B of the first pulp 150 into the pulp treating apparatus 100.

In this manner, the pulp treating apparatus 100 may keep taking X % recycled pulp 154 and (100%−X %) virgin pulp 152, for example. The constant X %, which is a positive real number in the range from 0 to 100, may be about 10%, for example, without limiting to this value. Alternatively, the pulp treating apparatus 100 may take about 10% recycled pulp 154 and about 90% virgin pulp at a first moment, and then adjust the intake such that the pulp treating apparatus 100 takes about 20% recycled pulp 154 and about 80% virgin pulp 152 at a second moment after the first moment. It is also possible that the pulp treating apparatus 100 may take about 70% recycled pulp 154 and about 30% virgin pulp at a first moment, and then adjust the intake such that the pulp treating apparatus 100 takes about 60% recycled pulp 154 and about 40% virgin pulp 152 at a second moment after the first moment.

Different types of the first pulp 150 may characteristically have different percentage of fines. Because of that, the pulp treating apparatus 100 requires less energy or work to reach a certain level of fines for the second pulp 160, the lower the percentage of fines the first pulp 150 has.

In an embodiment, the pulp treating apparatus 100 may perform the processing of fines from the first pulp 150 on the basis of the receptions in order to increase or decrease the percentage of fines.

In an embodiment, the pulp treating apparatus 100 may adjust separately a reception of the virgin pulp 152 and a reception of the recycled pulp 154, and perform the processing of fines from the first pulp 150 on the basis of the adjusted receptions.

In an embodiment, the pulp treating apparatus 100 may perform a feedback or a feedforward of information about the receptions of the plurality of the types of the first pulp 150 for a control of a process 102, 104, 106 prior to or subsequent to a process of the pulp treating apparatus 100.

In an embodiment, the pulp treating arrangement 100 may comprise or be connected with a measuring apparatus 200 that measures at least one of the following: fines content of the first pulp 150, fines content of a first part of the first pulp 150, fines content of reject rejected by the pulp treating apparatus 100, fines content of reject rejected by the first pulp treating sub-apparatus 100A, fines content of reject rejected by the second pulp treating sub-apparatus 100B, and a fines content of the second pulp 160. The pulp treating apparatus 100 may perform the processing of the fines from the first pulp 150 on the basis of the at least one measurement. The reject may comprise fines more than the second pulp 160 or the second pulp 160 may comprise more fines than the reject.

In an embodiment, the measuring apparatus 200 may comprise a measuring sensor 202, which measures the first pulp 150. Additionally or alternatively, the measuring apparatus 200 may comprise a measuring sensor 204 which measures the first pulp 160. In an embodiment, the measuring apparatus 200 may, irrespective to any other measurement, comprise a measuring sensor 206, which measures the reject removed from the first pulp 150. In an embodiment, the measuring apparatus 200 may comprise measuring sensor units, which measure the different types 152A, 152B, 154A, 154B of the first pulp 150 (the sensor units are illustrated as included in the measuring sensor 202 in FIG. 1).

In an embodiment, the pulp treating apparatus 100 may use energy, time and/or a suitable chemical for the pulp treatment as a function of the measured percentage of fines in order to reach a desired percentage of fines of the second pulp 160.

If a percentage of fines in the first pulp 150 or the second pulp 160 is at or below a desired level, the pulp treating apparatus 100 may use less energy, time and/or a suitable chemical for the treatment with respect to a situation where there is an excess of fines in the first pulp 150, the excess being required to be removed from the first pulp 150, for reaching a desired percentage of fines in the second pulp 160 and/or a desired quality of the product.

If there is an excess of fines in the first pulp 150 or in the second pulp 160, the pulp treating apparatus 100 may correspondingly increase usage of energy, time and/or a suitable chemical for the treatment as a function of an amount of the excess in order to reach a desired percentage of fines in the second pulp 160.

In an embodiment, the measuring apparatus 200 may perform a feedback or a feedforward of the at least one measurement for a control of a process 102, 104, 106 prior to or subsequent to a process of the pulp treating apparatus 100. In this manner, the prior process 106, the subsequent process 102 and/or the micro-/nanocellulose process 104 may use energy and/or a suitable process chemical as a function of the at least one measured percentage of fines that has been signaled as feed forward or feedback.

If there is too high a percentage of fines in the second pulp 160, the subsequent process 102 and/or in the micro-/nanocellulose process 104 may increase the usage of energy or the suitable chemical in order to reach a desired quality of the product with respect to a situation where no fines need to be removed from the first pulp 150 while still reaching a desired quality of the product. Namely, fines originating from the first pulp 150 and remaining in the second pulp 160 require more processing than fibers in order to have good quality of the microcellulose and/or nanocellulose.

If a percentage of fines in the second pulp 160 is at or below a desired level, the subsequent process 102 and/or in the micro-/nanocellulose process 104 may use less energy and/or a lower amount of the suitable chemical with respect to a situation where there is an excess of fines in the second pulp 160. The desired level of fines in the second pulp 160 may be as close as possible to zero. The desired level of fines in the second pulp 160 may be at or below 0.5%, for example.

In an embodiment an example of which is illustrated in FIG. 2, the pulp treating arrangement 100 may comprise or be connected with a process controller 300. On the basis of the at least one measurement performed by the measuring apparatus 200, the process controller 300 may control at least one of the following: the pulp treating apparatus 100, the micro-/nanocellulose process arrangement 104 and a process 102, 106 performed prior to or subsequent to the process of the pulp treating apparatus 100. The process controller 300 may increase the effectiveness of the pulp treating apparatus 100, the micro-/nanocellulose process arrangement 104 and/or the process 102, 106 performed prior to or subsequent to the process of the pulp treating apparatus 100, if the fines content of the second pulp is too high and/or increasing. The process controller 300 may decrease the effectiveness of the pulp treating apparatus 100, the micro-/nanocellulose process arrangement 104 and/or the process 102, 106 performed prior to or subsequent to a process of the pulp treating apparatus 100, if the fines content of the second pulp is suitable i.e., in an acceptable range and/or decreasing.

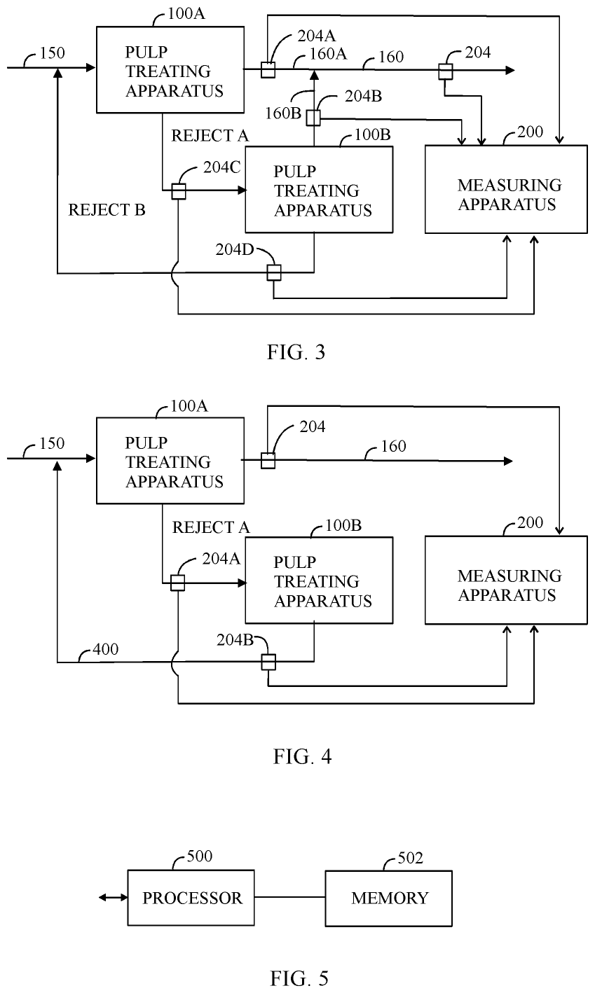

In an embodiment an example of which is illustrated in FIG. 3, the pulp treating apparatus 100 comprises at least two pulp treating sub-apparatuses 100A and 100B which are operationally connected. A first pulp treating sub-apparatus 100A may output a first part 160A of the second pulp 160 for the micro-/nanocellulose process 104. The first pulp treating sub-apparatus 100A may feed a reject A, which the first pulp sub-apparatus 100A removes from the first pulp 150, to a second pulp treating sub-apparatus 100B. Then the second pulp treating sub-apparatus 100B may output a second part 160B of the second pulp 160 for the micro-/nanocellulose process 104. Then the first part 160A and the second part 160B together form the second pulp 160. A reject B that the second pulp treating sub-apparatus 100B removes from the reject A may be fed back to the first pulp treating sub-apparatus 100A. The measuring apparatus 200 may measure, using sensors 204, 204A, 204B, 204C and/or 204D, at least one of the following: the second pulp 160, the first part 160A of the second pulp 160, the second part 160B of the second pulp 160, the reject A removed by the first pulp treating sub-apparatus 100A, and the reject B removed by the second pulp treating sub-apparatus 100B. Because the measured information determines effectiveness of the processing of the fines from the first pulp 150, it may be used to control at least one of the processes of the first and second pulp treating sub-apparatuses 100A, 100B. Additionally or alternatively, the measured information may be used to control the operation of a process prior to or subsequent to the process of the first and second pulp treating sub-processes 100A, 100B.

In an embodiment an example of which is illustrated in FIG. 4, the pulp treating apparatus 100 comprises at least two pulp-treating sub-apparatuses 100A and 100B, which have an operational cascade connection therebetween. A first pulp treating sub-apparatus 100A may output the second pulp 160 for the micro-/nanocellulose process 104. The first pulp treating sub-apparatus 100A may feed a reject A that the first pulp sub-apparatus 100A removes from the first pulp 150 to a second pulp treating sub-apparatus 100B. The second pulp treating sub-apparatus 100B may feed its output pulp 400 back to the first pulp treating sub-apparatus 100A. The measuring apparatus 200 may measure, using sensors 204, 204A and/or 204B, at least one of the following: the second pulp 160, the output 400 of the second pulp treating pulp 100B, and the reject removed by the second pulp treating sub-apparatus 100B. Because the measured information determines desired and/or achieved effectiveness of the processing of the fines of the first pulp 150, it may be used to control at least one of the processes of the first and second pulp treating sub-apparatuses 100A, 100B. Additionally or alternatively, the measured information may be used to control the operation of a process prior to or subsequent to the process of the first and second pulp treating sub-processes 100A, 100B.

Although FIGS. 3 and 4 illustrate only two pulp treating sub-apparatuses 100A, 100B, the number of the pulp treating sub-apparatuses is not limited to two but may be any positive integer larger than one.

The processing of fines which may be performed based on separation of the fines may be performed using one or more cyclones, one or more screens, flotation or the like by the pulp treating apparatus 100, the first pulp treating sub-apparatus 100A, and/or the second pulp treating sub-apparatus 100B. The cyclonic separator generates a vortex and the separation is based on centrifugal force. The first pulp 150 and/or the reject A may be filtered under pressure with the one or more pressure screens. Then the fines pass through the one or more screens but larger particles cannot pass through. Flotation, which typically refers to froth flotation, separates hydrophobic particles from hydrophilic particles. The fines may be made floatable and/or hydrophobic by adding one or more surfactant and/or frothing agent. Because a person skilled in the art knows how to perform the separation, per se, the invention is not limited to these devices and/or methods but any known separation may be used in the processing of fines. The separation may be used to modify i.e., increase or decrease the percentage of fines.

Any of the sensors 204, 204A, 204B, 204C, 204D, 206 may comprise an optical or a particulate gravimetric sensor. Any of the optical sensors 204, 204A, 204B, 204C, 204D may be based on scattering, absorption, attenuation and/or change in polarization of optical radiation caused by fines. Because the scattering, the absorption, the attenuation and/or the change in polarization of optical radiation depends in a deterministic manner on a relative amount of the fines in the first pulp 150, the second pulp 160, the reject A and/or the reject B, the measuring apparatus 200 may determine the percentage of the fines therein. Any of the optical sensors 204, 204A, 204B, 204C, 204D may be based on image capture of fines such that the measuring apparatus 200 may determine the percentage of the fines in the image on the basis of a relative image area covered by the fines, for example. The measuring apparatus 200 may determine the percentage of the fines using a suitable image processing computer program.

The particulate gravimetric sensor may have a filter, which is used to separate the fines from a known sample of the first pulp 150, the second pulp 160, the reject A and/or the reject B. Then the fines may be dried and weighted. The comparison between the dried fines and the known sample can be used to determine the percentage of the fines. The invention is not limited to these methods but any measuring method known to a person skilled in the art may be used.

In an embodiment an example of which is shown in FIG. 5, the process controller 300 may comprise one or more processors 500, and one or more memories 502 including computer program code. The one or more memories 502 and the computer program code may, with the one or more processors 500, cause the pulp treating apparatus 100 or the pulp treating sub-apparatus 100A, 100B at least to control an operation of the pulp treating apparatus 100 or the pulp treating sub-apparatus 100A, 100B and/or a process prior and/or subsequent to the pulp treating apparatus 100.

The controlling method explained earlier and referred to in FIG. 5 may be implemented as a logic circuit solution or computer program. The computer program may be placed on a computer program distribution means for the distribution thereof. The computer program distribution means is readable by a data processing device, and it encodes the computer program commands, carries out the measurements and optionally controls the processes on the basis of the measurements.

The computer program may be distributed using a distribution medium, which may be any medium readable by the process controller. The medium may be a program storage medium, a memory, a software distribution package, or a compressed software package. In some cases, the distribution may be performed using at least one of the following: a near field communication signal, a short distance signal, and a telecommunications signal.

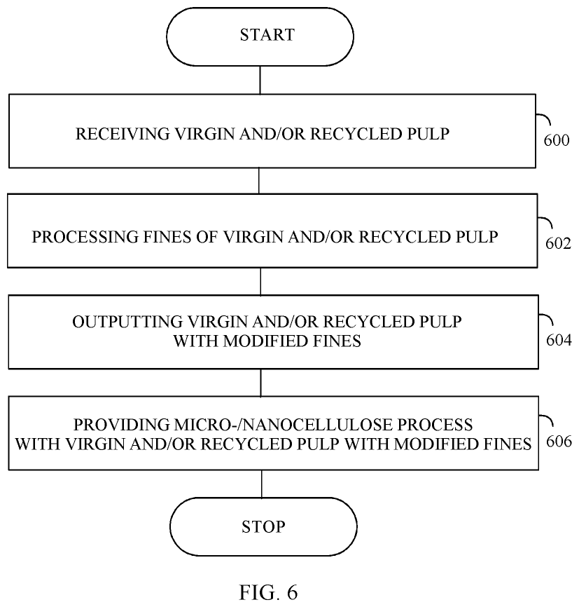

FIG. 6 illustrates a flow chart of the pulp treating method. In step 600, receiving first pulp 150 by a pulp treating apparatus 150, the first pulp 150 comprises at least one of the following: virgin pulp 152 and recycled pulp 154. In step 602, a processing of fines of the first pulp 150 is performed. In step 604, a second pulp 160 having a modified percentage of fines is output from the pulp treating apparatus 100 based on the processing of fines. In step 606, a micro-/nanocellulose process arrangement 104 is provided with the second pulp 160.

It will be obvious to a person skilled in the art that, as technology advances, the inventive concept can be implemented in various ways. The invention and its embodiments are not limited to the example embodiments described above but may vary within the scope of the claims.

1-10. (canceled)

11. A pulp treating arrangement comprising:
at least one of a first source of virgin pulp and a second source of recycled pulp connected to a first pulp treating apparatus, wherein the first pulp treating apparatus forms a source of treated pulp in communication with a second treating apparatus which forms a source of nanocellulose, wherein the first pulp treating apparatus is configured to modify the percentage of fines of pulp processed therein;
wherein the first pulp treating apparatus also forms a source of reject which differs from the source of treated pulp in having one of: more fines or less fines;
a measuring apparatus;
a first sensor arranged to measure fines in the first source of virgin pulp, the first sensor being connected to the measuring apparatus;
a second sensor arranged to measure fines in the second source of recycled pulp, wherein the second sensor is connected to the measuring apparatus;
a third sensor arranged to measure fines in the source of reject, wherein the third sensor is connected to the measuring apparatus;
a fourth sensor arranged to measure fines in the source of treated pulp between the first pulp treating apparatus and the second pulp treating apparatus which forms the source of nanocellulose; wherein the fourth sensor is connected to the measuring apparatus;
wherein the measuring apparatus on the basis of at least one measurement of fines made by the sensors is arranged to control the treatment of pulp carried out by the first pulp treating apparatus or the second pulp treating apparatus.

12. The pulp treating arrangement of claim 1 further comprising a third pulp treating apparatus arranged to further process the source of treated pulp before communicating the source of treated pulp to the second treating apparatus which forms a source of nanocellulose.

13. The pulp treating arrangement of claim 1 further comprising devices which process virgin pulp before the virgin pulp forms the first source of virgin pulp or which process recycled pulp before the recycled pulp forms the second source of recycled pulp.

14. The pulp treating arrangement of claim 13 further comprising a process controller connected to the measuring apparatus to receive output from the first sensor, the second sensor, the third sensor and the fourth sensor;
wherein the process controller is connected to control the devices which process virgin pulp before the virgin pulp forms the first source of virgin pulp or which process recycled pulp before the recycled pulp forms the second source of recycled pulp;
wherein the process controller is connected to the first pulp treating apparatus;
wherein the process controller is connected to the second pulp treating apparatus which forms the source of nanocellulose.

15. The pulp treating arrangement of claim 11 further comprising a process controller connected to the measuring apparatus to receive output from the first sensor, the second sensor, the third sensor and the fourth sensor;
wherein the process controller is connected in a controlling relationship to the first pulp treating apparatus;
wherein the process controller is connected in a controlling relationship to the second pulp treating apparatus which forms the source of nanocellulose; and
wherein the process controller is connected to a third pulp treating apparatus arranged to further process the source of treated pulp before communicating the source of treated pulp to the second treating apparatus which forms a source of nanocellulose.

16. The pulp treating arrangement of claim 15 wherein the process controller is connected in a controlling relationship to the devices which process virgin pulp before the virgin pulp forms the first source of virgin pulp and which process recycled pulp before the recycled pulp forms the second source of recycled pulp.

17. The pulp treating arrangement of claim 11 wherein the first pulp treating apparatus has a first part forming the source of reject which differs from the source of treated pulp in having one of: more fines or less fines;
wherein the first pulp treating apparatus has a second part which receives the source of treated pulp rejects, and forms a second source of reject which feeds in to the first part along with the at least one of the first source of virgin pulp and the second source of recycled pulp; and
wherein the measuring apparatus is connected to a fifth sensor arranged to measure fines in the second source of reject.

18. The pulp treating arrangement of claim 17 wherein the second part provides an output which is combined with the source of treated pulp in communication with the second treating apparatus which forms a source of nanocellulose; and
a sixth sensor arranged to measure fines in the combined second part output and the source of treated pulp from the first pulp treating apparatus before the combination is communicated to the second treating apparatus which forms a source of nanocellulose.

19. A pulp treating arrangement comprising:
a source of virgin pulp;
a source of recycled pulp;
a first pulp treating apparatus, which is configured to receive a first pulp from at least one of the source of virgin pulp and the source of recycled pulp, the first pulp treating apparatus discharging a second pulp for further treatment and a reject;
a first sensor arranged to measure a fines content of the first pulp;
a second sensor arranged to measure a fines content of the reject;
a third sensor arranged to measure a fines content of the second pulp;
wherein a process controller is configured to receive a measurement from at least one of the first sensor, the second sensor and the third sensor, and to control at least the first pulp treating apparatus;
wherein the first pulp treating apparatus is configured to process fines of the first pulp on the basis of the received measurement as controlled by the controller, and output the second pulp having a modified percentage of fines on the basis of the processing of fines within the first pulp treating apparatus; and
a micro-/nanocellulose process arrangement which receives and treats the second pulp.

20. The pulp treating arrangement of claim 19 wherein the first pulp treating apparatus is configured to perform the processing of fines of the first pulp on the basis of receptions of a plurality of types of the first pulp.

21. The pulp treating arrangement of claim 19 wherein the first pulp treating apparatus is configured to receive a plurality of types of the pulp from a plurality of sources of pulp including a plurality of types of virgin pulp, a plurality of types of recycled pulp; and
wherein the first pulp treating apparatus is configured to adjust separately receptions of the plurality of the types of pulp.

22. The pulp treating arrangement of claim 21 further configured to perform a feedback or a feedforward of information about the receptions of the plurality of the types of the first pulp to the first pulp treating apparatus for a control of a process prior to or subsequent to a process of the first pulp treating apparatus.

23. The pulp treating arrangement of claim 19 further comprising a measuring apparatus configured to perform a feedback or a feedforward of the received measurement for control of a process prior to or subsequent to the first pulp treating apparatus to use energy or a suitable process chemical.

24. The pulp treating arrangement of claim 19 wherein the pulp treating arrangement further comprises a process controller configured to control, on the basis of the received measurement, at least one of the following: the first pulp treating apparatus, the micro-/nanocellulose process arrangement and a process performed prior to or subsequent to the first pulp treating apparatus.

25. The pulp treating arrangement of claim 19 wherein the first pulp treating apparatus comprises a first pulp treating sub-apparatus configured to feed reject of the first pulp treating sub-apparatus to a second pulp treating sub-apparatus, and an output of the first pulp treating sub-apparatus and an output of the second pulp treating sub-apparatus are combined to form the second pulp; and
wherein sensors are positioned to measure the fines content of the outputs of the first pulp treating sub-apparatus and second pulp treating sub-apparatus and to communicate measurements of said sensors to a process controller.

26. A pulp treating method, comprising the steps of:
receiving a first pulp in a first pulp treating apparatus, the first pulp including at least one of virgin pulp and recycled pulp;
measuring the fines content of the first pulp;
processing the received first pulp within the first pulp treating apparatus and outputting therefrom a second pulp and a reject;
measuring the fines content of the second pulp;
measuring the fines content of the reject;
performing a processing of fines of the first pulp on the basis of at least one of the measured fines content;
outputting the second pulp having a modified percentage of fines on the basis of the processing of fines within the first pulp treating apparatus; and
providing the output second pulp to a micro-/nanocellulose process arrangement.
